(19) United States
(12) Patent Application Publication
(10) Pub. No.: US 2008/0168358 A1
(43) Pub. Date: Jul. 10, 2008

(54) Single-page web signup facility

(75) Inventors: Reid Maker, Seattle, WA (US); Arun Rajappa, Redmond, WA (US); Volodymyr Otryshko, Redmond, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/650,714

(22) Filed: Jan. 8, 2007

(51) Int. Cl. G06F 3/00

(52) U.S. Cl. 715/744

(57) ABSTRACT

Embodiments of the invention provide a single-page signup facility that provides the user with a clear visual indication of the information to be provided, and steps to be completed, during a signup process. The single-page signup facility presents a plurality of modules, each designed to collect a portion of the signup information, which may be arranged vertically so that the user may see all of the modules in a single viewable area on the page. The modules may be interactive and change state on the page (e.g., by expanding and collapsing) to collect information from the user while also conserving viewable area on the page.

### FIELD OF INVENTION

This invention relates to web page signup facilities.

### BACKGROUND OF INVENTION

Many web sites provide facilities which a user may employ to order, register, sign up for, or otherwise establish a relationship with a product and/or service (these facilities are referred to generically herein as “signup facilities,” and the process by which a relationship is created between the user and the product/service a “signup process”). Conventionally, a signup facility includes one or more web pages which accept user input of various information to complete the signup process (referred to herein as “signup information”), such as the user's first and last name, billing and/or mailing address, credit card number, and/or other information.

Conventionally, if a substantial amount of information is to be collected from a user via a signup process, a signup facility presents multiple web pages to the user, each allowing the user to provide a portion of the signup information required. As a result, the user typically provides a first portion of signup information to a first web page and indicates (e.g., by clicking on a “continue” button on the page) that the process should continue to the next page. When this occurs, browser software executing on the user's device (e.g., a personal computer, cell phone, personal digital assistant or other device) transmits the signup information to a server along with a request for the next web page in the signup facility. The server computer receives the signup information provided, retrieves the next web page, and transmits it to the browser. The user may experience a delay while the browser generates the information and transmits it to the server, and the server processes the received information and transmits the next page back to the browser.

### SUMMARY OF INVENTION

Applicants have appreciated that signup facilities which collect signup information via multiple web pages are less effective than single-page signup facilities at converting users to signed-up customers. For example, some users may not wish to expend the time or effort required to provide signup information to multiple web pages, and in fact many multiple-page signup facilities experience significant user drop-off from one web page to the next. In addition, most signup facilities that span multiple web pages provide the user with no clear sense of the total amount of information to be provided or the total number of steps the signup process entails. Thus, some users can become frustrated, feel that no clear end is in sight, and abandon the signup process.

Accordingly, one embodiment of the invention provides a signup facility which provides the user a visual indication of the steps to be completed during the signup process on a single page. The single-page signup facility may present a plurality of modules on the page, each designed to collect a different portion (a group of logically related items) of the signup information. The modules may be arranged in a manner which allows the user to see all modules in a single viewable area (e.g., without having to scroll down the page to see the modules). For example, in some embodiments, modules are arranged vertically (i.e., in a column, or an approximation thereof) on the page. As a result, the user is given a clear visual indication of the overall scope of the signup process, and the amount and nature of information to be provided. As a result, a signup facility may collect a substantial amount of information from the user without presenting multiple web pages, and while providing the user with an indication of the overall process and where the user is in that process at any point in time.

In one embodiment, the modules presented to the user via the signup facility are interactive and change between states that facilitate collection of information from the user, and conserving “real estate” (i.e., viewable area) on the web page when the module is not being used to collect information. For example, when modules are first presented on the page, they may be presented in a collapsed state, so that the user gets a sense of the total amount of signup information to be provided in a compact visual presentation. When a user indicates a willingness to provide input to a module, the module may change to an expanded state to display input mechanisms (e.g., text boxes, dropdown menus, buttons, and/or other mechanisms) so that the user may provide signup information. When the user indicates that he or she is done providing input to one module and wishes to proceed to a next module, the first module may change to a summary state wherein the input mechanisms are no longer displayed, so that the module no longer occupies a significant portion of the viewable area on the page. In its summary state, a first module may present a summary of the signup information previously supplied by the user, such as a portion of the information which the user may later wish to edit. The next module may change to its expanded state to present input mechanisms to the user. In this manner, the user can step through all the modules with only one expanded at a time and the others conserving space. As the user proceeds through the signup process from one module to the next, the user may be given a clear indication of the input he or she previously provided, the input currently requested, and the input yet to be provided, in a single viewable area.

In some embodiments, modules are implemented via components which facilitate asynchronous communication between the browser and server, such that the browser need not request a new page from the server when the user indicates a willingness to proceed from one module to the next. As a result, the apparent latency (i.e., from the user's perspective) between user action and application response may be reduced, and the signup facility may appear to the user to be as responsive as an application executing on the client. For example, in some embodiments, individual modules are implemented as Javascript objects, and the execution of modules is orchestrated by a client-side platform implemented via asynchronous java script and XML (AJAX). In some embodiments, a server-side platform is also implemented on the server to provide information to, and collect information from, the client-side platform via the browser. The functionality provided by these and other components is described in further detail below.

### BRIEF DESCRIPTION OF DRAWINGS

The accompanying drawings are not intended to be drawn to scale. In the drawings, each identical or nearly identical component illustrated in the various figures is represented by a like numeral. For purposes of clarity, not every component may be labeled in every drawing. In the drawings:

FIGS. 1A-1C each depict an exemplary graphical user interface displaying a single-page signup facility in accordance with some embodiments of the invention;

FIG. 2 is a block diagram depicting exemplary components for providing a signup facility in accordance with some embodiments of the invention;

FIG. 3 is a flowchart depicting an exemplary process for providing a single-page signup facility, in accordance with some embodiments of the invention;

FIG. 4 is a block diagram depicting an exemplary computer system, with which aspects of embodiments of the invention may be implemented; and

FIG. 5 is a block diagram depicting an exemplary computer memory on which programmed instructions comprising embodiments of the invention may be stored.

### DETAILED DESCRIPTION

One embodiment of the present invention provides a signup facility presented via a single web page, such that the user is given a clear visual indication of the overall scope of, and information to be provided during, the signup process. The signup facility page may present a plurality of modules, each of which is designed to collect a portion of the information to be collected overall. In some embodiments, the modules are arranged (e.g., vertically, in a columnar orientation) on the signup facility page in a manner that enables the user to see all of the modules in a single viewable area (e.g., without requiring the user to scroll down the page). Of course, the invention is not limited to such an arrangement, as any number of modules may be arranged in any suitable manner.

To allow modules to be presented to the user in a single viewable area on the page (or an approximation thereof), in some embodiments, each module is capable of changing state. For example, when they are not actively receiving information from a user, modules may be presented in a collapsed state to conserve real estate, but when a user indicates a willingness to provide signup information to a particular module, that module may change from a collapsed state to an expanded state, wherein one or more input mechanisms (e.g., text boxes, dropdown menus, buttons, and/or other mechanisms) are presented to capture user input. After the user has finished providing input via that particular module, or otherwise indicates a willingness to proceed to another module, the module may, for example, change to a summary state, wherein a portion of the input provided by the user is displayed. A next module may then automatically expand to display one or more input mechanisms. In this manner, all modules may be presented in a single viewable area while giving the user a clear indication of where he or she is in the signup process overall, including the extent of signup information that the user is yet to provide. However, although employing modules which are capable of changing state may conserve viewable area on the signup page, the invention is not limited to such an implementation. For example, one or more modules presented via a signup facility may not be capable of changing state, any suitable collection of modules, having any suitable respective capabilities, may be implemented. In addition, in some embodiments, modules capable of changing state are not employed.

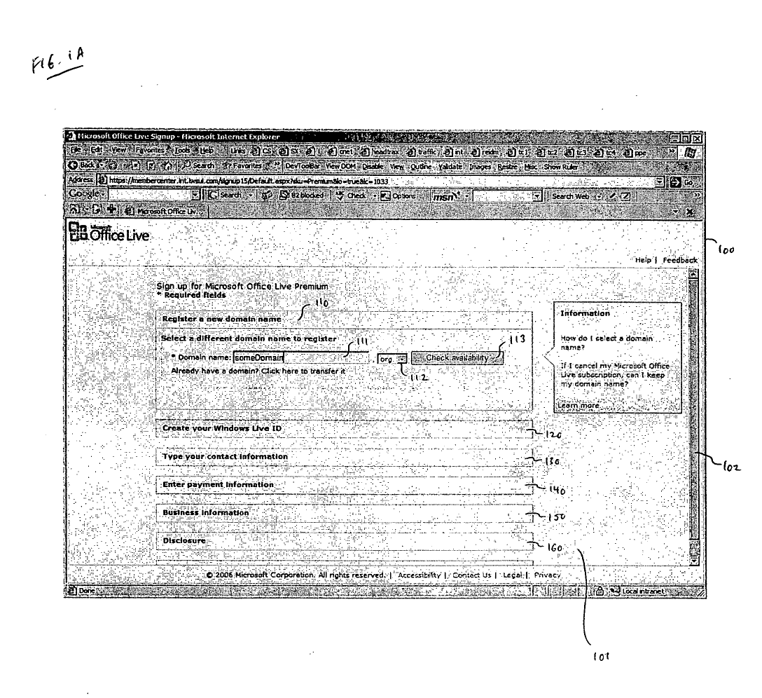

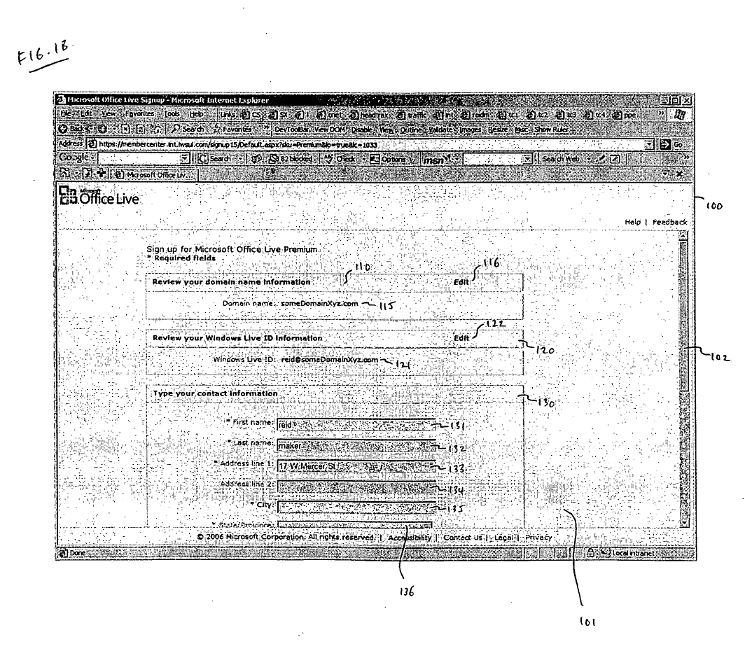

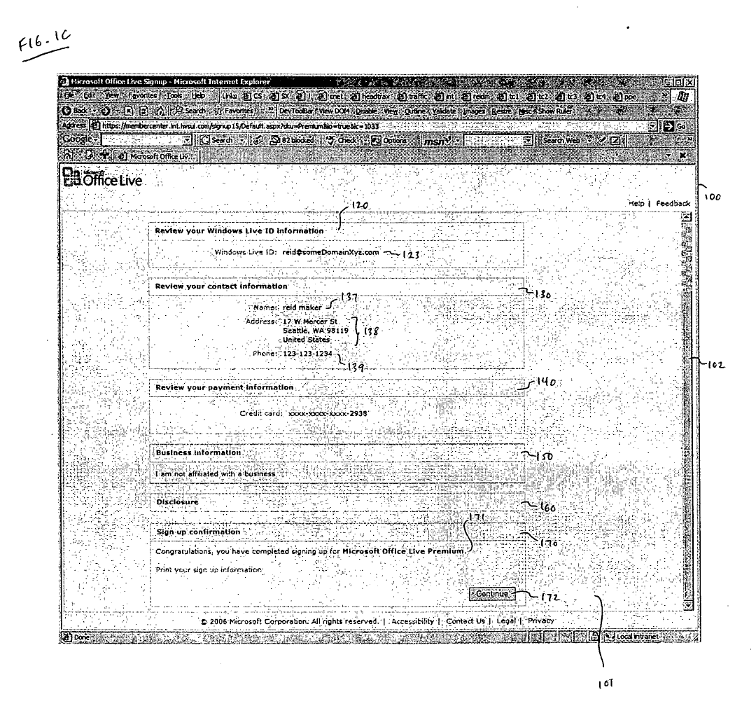

FIGS. 1A-1C depict one example of a signup facility 101 which includes a plurality of modules capable of changing state in accordance with one embodiment of the invention. FIG. 1A depicts graphical user interface (GUI) 100 presented via browser software. In the example shown, the browser software is Microsoft Internet Explorer, offered by Microsoft Corporation of Redmond, Wash., although any suitable browser software may be employed. GUI 100 may be presented via browser software executing on any suitable device, including a personal computer, personal digital assistant, cellular telephone, or other device, as the invention is not limited in this respect.

In the example shown, signup facility 101 allows a user to provide signup information to order the Microsoft Office Live Premium product offered by Microsoft Corporation. In this example, providing signup information includes registering a new domain name via module 110, creating a Windows Live ID via module 120, providing contact information via module 130, entering payment information via module 140, providing business information via module 150, and acknowledging disclosure information via module 160. Of course, a signup facility implemented in accordance with embodiments of the invention may accept any suitable information relating to any suitable product or service, as the invention is not limited in this respect. In the example shown, modules 110-160 are presented in approximately a single viewable area, such that the user is given a clear sense of the types of information to be provided in the signup process overall without having to scroll down the web page (e.g., using scroll bar 102).

In FIG. 1A, module 110 is shown in an expanded state, such that it presents input mechanisms 111, 112 and 113. More particularly, module 110 presents text box 111, drop-down box 112 and button 113. Any suitable number and type of input mechanisms may be presented by a module, as the invention is not limited in this respect. In the example shown, text box 111 allows the user to specify a domain name to be registered, drop-down box 112 allows the user to select from a list of top-level domains, and button 113 allows the user to check the availability of the domain specified via input mechanisms 111-112. Of course, other types or combination of input mechanisms may be provided to collect this information from a user.

In the example shown in FIG. 1A, the user is currently providing input to module 110, such that the user has not yet reached any of modules 120-160. In contrast to module 110, each of modules 120-160 is shown in a collapsed state. In some embodiments, a module is shown in a collapsed state when a user has not yet reached (e.g., provided input to) the module, so that the module occupies a minimal amount of the viewable area on the page. However, the invention is not limited to such an implementation, as not all (or none of the) modules that have not received information need be shown in a collapsed state.

FIG. 1B depicts exemplary signup facility 101 as the user provides input to module 130 (e.g., after having provided input to module 110 as shown in FIG. 1A, and to module 120 via interaction which is not shown). In the example shown, modules 110 and 120 are shown in a summary state, such that each presents a summary of the input provided by the user to the module. Specifically, module 110 presents text 115 which indicates the domain name specified by the user via module 110 when the module was in the expanded state (as shown in FIG. 1A). Module 110 also presents link 116, which the user may click to edit the domain name indicated by text 115. In some embodiments, by clicking on link 116, the user may cause module 110 to change to the expanded state to present text box 111, drop-down box 112 and button 113 to allow the user to specify a new domain name, although the invention is not limited to such an implementation. Clicking on link 116 may also cause module 130 to change back to the summary state, so as to not occupy viewable area on the page. However, the invention is not limited to presenting any module in any particular state when a user indicates a desire to modify input previously provided. For example, module 110 may remain in a summary state but present a single text box that enables the user to change the domain name, and/or module 130 may remain in an expanded state whether or not module 110 changes to an expanded state. Embodiments of the invention may be implemented in any suitable fashion.

In the example shown in FIG. 1B, module 130 allows the user to provide contact information. In the example shown, module 130 is in an expanded state, and presents text boxes 131-135, via which the user may specify his or her first name, last name, “address line 1,” “address line 2” and city, respectively. The user may employ drop-down box 136 to specify his or her state.

It should be appreciated that by presenting modules to which the user has already provided input in a summary state, the module(s) to which the user is currently providing input in an expanded state, and the module(s) to which the user has yet to provide input in a collapsed state, the embodiment of the signup facility depicted provides the user with a clear indication of where he or she is in the signup process, what information has been provided, and what information he or she has yet to provide in the signup process overall.

FIG. 1C depicts exemplary signup facility 101 after the user has completed the signup process. In the example shown, each of modules 120-160 is shown in a summary state and presents a summary of input provided by the user. In the example shown, none of modules 120-160 provide a mechanism to allow the user to edit this input (e.g., via a link similar to link 116 shown in FIG. 1B), as the user has completed the signup process and the information has been recorded. Of course, the invention is not limited to such an implementation, as a mechanism can be provided to modify information.

Module 170 is also shown by signup facility 101 to present a congratulatory message to the user via text 171 indicating that the signup process has been completed. Module 170 presents button 172, which the user may employ to proceed to another page (e.g., to exit the signup facility). For example, by clicking button 172, the user may proceed to a page which allows him or her to use the product or service for which he or she has registered.

It should be appreciated that signup facility 101 and the modules displayed thereby are merely exemplary, and that signup facilities and/or modules implemented in accordance with embodiments of the invention may differ in any of numerous respects from the signup facility and modules shown. For example, a module in an expanded state need not display the types of input mechanisms described above with reference to FIGS. 1A-1C, as type or combination of input mechanisms may be employed to collect information from a user. Similarly, a signup facility need not initially show all modules in a collapsed state, as any suitable number (including zero) of modules may be shown in any state at any one time. In addition, a module in a summary state may display any type or combination of information, including information not provided by a user. The invention is not limited to any particular implementation.

As described above, in some embodiments, signup facility 101 and/or any of modules 110-170 may be implemented via components which enable asynchronous communication between the browser software and server, such that the browser need not request a new web page from the server when, for example, the user proceeds from one module to another. Implementation via components which facilitate asynchronous communication may, for example, minimize the latency experienced by the user while employing the signup facility, such that the signup facility appears to the user to be as responsive as an application executing on the client.

For example, in some embodiments, a single-page signup facility is presented by a client-side platform which orchestrates the execution of one or more modules, and is implemented via asynchronous Javascript and XML (AJAX). In some embodiments, individual modules are implemented as Javascript objects. As will be appreciated by those skilled in the art, the use of AJAX enables the server to download code to the browser which can run on the client machine to interact with the user to collect and store signup information without needing to interact with the server. However, the aspect of that employs asynchronous communication is not limited to such an implementation. For example, if asynchronous communication between the browser and server is desired, any of numerous components may be employed, such as iframes, hidden frames, image requests and cookies, active X controls, and/or other components.

The invention is not limited to being implemented with components that facilitate asynchronous communication. Any suitable components may be employed to implement some embodiments of the invention, including components that require synchronous communication between the client and server.

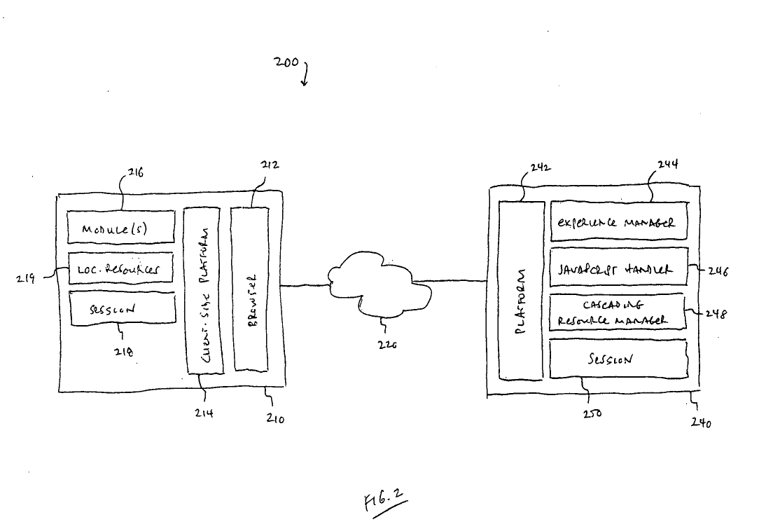

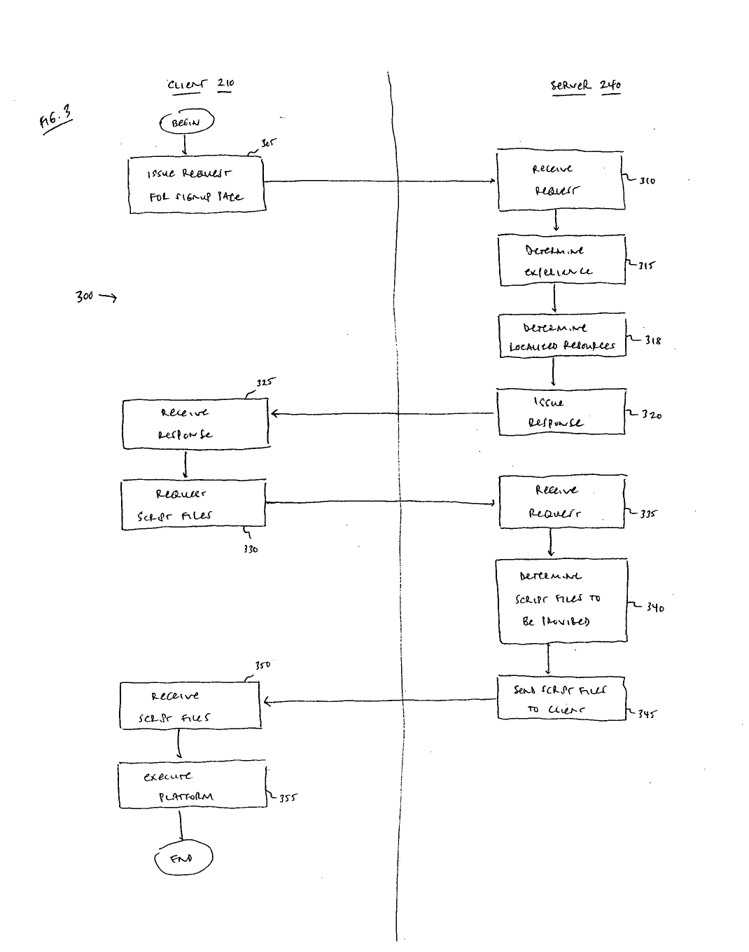

Exemplary processing which is performed to present a single-page signup facility in accordance with embodiments of the invention is described below with reference to FIGS. 2 and 3. FIG. 2 depicts exemplary components which may be employed to present a single-page signup facility, and FIG. 3 depicts exemplary processing which may be performed by those components to present a single-page signup facility.

FIG. 2 depicts system 200 in which a client computer 210 and server 240 communicate via network 220, using any suitable communication protocol and/or infrastructure. Client 210 includes browser 212, client-side platform 214, module(s) 216 (examples of which were discussed above) and session data 218. Briefly, client-side platform 214 orchestrates the execution of one or more modules 216, and coordinates the presentation of module(s) 216 via browser 212 on client 210. In doing so, platform 214 may employ session data 218, (e.g., to manage interaction between one or more of module(s) 216). All of the components on client 210 may be downloaded to client 210 during the process of FIG. 3, described below, although the client typically will have a browser program loaded thereon so that it need not be downloaded.

Server 240 includes server-side platform 242, experience manager 244, Javascript handler 246, cascading resource manager 248, and server session data 250. Briefly, server-side platform 242 receives page requests issued by browser 212 (e.g., requests for a single-page signup facility), and responds to these requests by providing the components described above to client 210 (i.e., components 216, 218, 219, and 214). In so doing, server-side platform 212 manages the execution of experience manager 244, Javascript handler 246 and cascading resource manager 248. After server-side platform 242 provides the above-described components to client 210, it may employ server session data 250 in processing asynchronous communication from the browser, as described below. These and other functions provided by the components of system 200 are described in more detail below with reference to FIG. 3.

FIG. 3 depicts process 300, which may be performed by the components of system 200 to provide a single-page signup facility to a user of browser 212. At the start of process 300, a request is issued by client 210 (and more particularly, by browser 212) for a single-page signup facility. For example, the user may provide input via browser 212 indicating that the signup facility should be presented, such as by clicking a link presented by browser 212 to sign up for a particular product or service. The request is transmitted via network 220 to server 240.

In act 310, the request is received at server 240 by server-side platform 242. In act 315, an “experience” to be presented to the user via the signup facility is determined. In this respect, in accordance with some embodiments of the invention, server-side platform 242 is capable of presenting multiple variations of a single-page signup facility to the user via browser 212, wherein each variation may include a different combination and/or number of modules. For example, different modules may be included, and/or modules may be arranged in different ways, in each variation of the signup facility, so as to create a particular user experience. This may be done for any of numerous reasons. For example, a first experience may be defined for a first (e.g., basic) version of a product/service, and another experience may be defined for a second (e.g., premium) version. In another example, different experiences may each define a different offer or marketing message with respect to a particular product. In yet another example, different experiences may each define the same offer or marketing message, but may be presented to different users to test the effectiveness of different experiences in converting users to signed-up customers.

In some embodiments, to determine the experience to be presented to the user, server-side platform 242 first determines the product or service to which the request relates. This information may be provided, for example, within the request issued in act 305. For example, the uniform resource locator (URL) defined by the request (e.g., defined by the link clicked by the user in act 305) may define the product or service to which the request relates. Server-side platform 242 then communicates with experience manager 246, which determines the experiences available for the product or service and which experience is to be presented to the user. This determination may be made in any of numerous ways. For example, if there are multiple experiences available for the product or service, experience manager 244 may employ an algorithm to determine which experience is presented to the user. As an example, if experiences A and B are available for presentation, an algorithm may define that experience A is presented to eighty percent of users, and experience B is presented to twenty percent of users. Experience manager 244 may employ the algorithm to define whether A or B is presented to the user, and communicate the chosen experience to server-side platform 242.

It should be appreciated that the invention is not limited to employing multiple experiences for a signup facility, such that in some embodiments, experience manager 244 may not be employed and/or implemented.

In act 318, localized resources to be provided to the browser are determined. In this respect, in accordance with some embodiments of the invention, server-side platform 242 is capable of presenting a single-page signup facility to the user that is customized according to certain characteristics of the user's request. For example, if the user's request is issued from a specific geographic location, a signup facility may be presented which includes modules and/or input mechanisms labeled with text in the appropriate language and/or character set.

In some embodiments, server-side platform 242 determines whether localized resources are required using information provided in the request issued in act 305. For example, the uniform resource locator (URL) defined by the request (e.g., defined by the link clicked by the user in act 305) may define whether localized resources are needed. For example, the user may have clicked a link to order a German language version of a specific product/service, or the URL defined by the request may have a top-level domain (e.g., .de) which indicates that the user is German. Server-side platform 242 then communicates with cascading resource manager 248, which determines the localized resources for the signup facility.

In act 320, a response is issued to browser 212. In some embodiments, the response includes one or more script URLs which include encoded parameters. The script URL may define (e.g., using an identifier encoded within the URL) the experience defined by experience manager 244 in act 315, and any localized resources defined by cascading resource manager 248 in act 318.

In act 325, the response is received by browser 212, and in act 330, the browser issues a second request to server 240. In some embodiments, browser 212 employs the script URL provided in act 320 to request one or more script files which may be employed by the browser to present a single-page signup facility to the user.

In act 335, the server receives the request, and in act 340, server-side platform 242 determines the script files to be provided to client 210 to present a signup facility which provides the experience determined in act 315 and any localized resources defined in act 318. In some embodiments, server-side platform 242 communicates one or more identifiers for the experience and/or localized resources to Javascript handler 246, which maintains the files which are provided to the browser to generate the experience. The Javascript handler 246 transmits the files to client 210 in act 345 in any suitable way (e.g., loads the appropriate script files to memory on server 240).

The files sent to the client in act 345, may include programmed instructions and data defining client-side platform 214, each of module(s) 216 and localized resources 219.

As described above, localized resources 219 enable modules 216 to be defined independently of the context in which they are presented to the user. For example, a particular module may collect contact information from the user (as shown by module 130, FIGS. 1A-1C). Such a module may employ information provided by localized resources 219 to present input mechanisms (e.g., text boxes 131-135, FIG. 1B) labeled with text that is appropriate for a specific context, such as a specific country or region (e.g., in the appropriate language and/or character set). In some embodiments, localized resources 219 store this information as a series of name/value pairs, such that a module may call for a particular name, and the value associated with the name is presented to the user on the signup facility. For example, the contact information module may specify that the input mechanism for collecting the user's first name is labeled with the value associated with the field name “first_name.” The value may, for example, be the German equivalent to the text “first name.”

In act 350, the script files are received by client 210, and in act 355, are executed by browser 212. Act 355 is described in detail in the paragraphs that follow. At a high level, browser 212 executes client-side platform 214, which manages the execution of module(s) 216 to present the signup facility via browser 212. Upon the completion of act 355, process 300 ends.

It should be appreciated that process 300 is merely exemplary, and that a single-page signup facility having the capabilities and features described herein may be presented to a user using any suitable processing technique(s). Further, it should be appreciated that acts 305-355 need not be performed in the manner or order described above, that any of acts 305-355 may be omitted or replaced, and that one or more additional acts may be performed. Numerous variations on process 300 are possible. As an example, in some embodiments, it may not be necessary for the browser to issue two requests to the server for instructions and data defining a single-page signup facility (as is described above with reference to acts 305 and 330), and that such instructions and data may be provided to a browser in response to a single request. In another example, the instructions and data defining the signup facility need not comprise separate client-side platform, module and localized resources files, as the data and instructions can be organized in any number (including one) of functional components. The invention is not limited to any particular implementation technique.

It should also be appreciated that system 200 is merely exemplary, and that a single-page signup facility having the features and capabilities described herein may be implemented using any suitable type and/or combination of components. For example, any of the functionality described with reference to the various components of system 200 may be provided by any suitable component, including components not shown.

In some embodiments, client-side platform 214 is designed to be generic, in that any number and type of module(s) 216 may be presented via the signup facility. This may allow for modularization of different aspects of the system for presenting signup pages and experiences. For example, the capabilities of moving between modules, changes module states, etc., can be performed generically by the platform irrespective of the specifics of a particular module, so that each module need not be provided with capabilities to control these functions. Different parties may supply different modules for presentation in a single signup facility, and particular modules may be modified or replaced without requiring changes to the client-side platform. As such, the system shown in FIG. 2 may be scalable to suit any number of users, products, services, and/or experiences desired.

The execution of client-side platform 214, and by extension module(s) 216, to present a single-page signup facility, may entail various processing steps. For example, using the example described above with reference to FIGS. 1A-1C, client-side platform 214 may, when a user indicates a willingness to move from module 120 to module 130 (FIG. 1B), orchestrate the execution of module 120 so that it changes from an expanded state to a summary state, and of module 130 so that it changes from a collapsed state to an expanded state, as shown in FIG. 1B. In some embodiments, modules may be implemented as Javascript objects. As is well-understood by those skilled in the art of software engineering, Javascript objects include programmed instructions which, when executed by the browser, can cause portions of a web page display to change appearance, such as by changing state as described above.

Client-side platform 214 may maintain browser history as a user progresses from one module to another within the signup facility. For example, in some embodiments, when a user provides input to a first module (e.g., module 120, FIG. 1B), moves to another module (e.g., module 130) to provide input thereto, and then indicates a willingness to return to the first module (e.g., by clicking the “back” button within browser 212), client-side platform 214 may process the browser command to return to the first module. For example, in some embodiments, client-side platform 214 causes the second module to change to a collapsed state and the first module to change an expanded state in which its input mechanisms are presented. Thus, embodiments of the invention may provide a signup facility which, although presented to the user via a single web page, allows the user to navigate between modules using conventional browser actions as though the signup facility included multiple pages, in a manner which is familiar to the user.

In some embodiments, client-side platform 214 performs various event handling functions. For example, in some embodiments, after the user has provided input to all modules on the signup facility and indicates a willingness to finish the signup process (e.g., by clicking a “purchase” button provided by the signup facility), client-side platform 214 may poll one or more modules presented on the signup page to determine whether allowing the user to finish is desirable. Allowing the user to finish may be undesirable for several reasons. For example, a particular module may be performing processing (e.g., making a call to a web service) which should be completed before the signup process may be finished. Using the example described with reference to FIGS. 1A-1C, a user may provide input to all of modules 110-160, then decide to change the domain name via module 110 (e.g., by clicking link 116, FIG. 1B), and then immediately attempt to conclude the signup process. Given that the email account specified in module 120 is driven by the domain name specified in module 110, concluding the signup process immediately after the domain name is changed may not be desirable, since module 120 may be attempting a network call to determine whether the email account corresponding to the new domain name is available.

Accordingly, in some embodiments, when the user indicates that the signup process should be concluded, client-side platform 214 polls module(s) 216 to determine whether this is desirable. In some embodiments, if a module is processing a network call, or otherwise indicates that the signup process should not be concluded, the client-side platform may not allow the process to be completed. For example, client-side platform may present a message to the user indicating that he or she should wait a short period, then try again to conclude the process. If no polled module indicates that the process should not be completed, client-side platform 214 may allow the signup process to be concluded.

In some embodiments, client-side platform 214 notifies modules on the signup facility when the signup process is completed. If completion of the signup process fails (e.g., a credit card number provided by the user is not approved), in some embodiments, client-side platform 214 causes one or more modules on the signup facility to revert to their previous state (i.e., before completion of the signup process was attempted). For example, client-side platform code may cause all of the modules to change to a summary state, so as to provide a summary of input previously provided by the user.

Client-side platform 214 may perform other error handling functions. For example, a signup facility may include a first module which allows a user to provide credit card information and a second module that allows the user to initiate a purchase transaction using the credit card information provided via the first (credit card) module. The second module may, for example, be configured to make a network call to a billing gateway to execute the purchase. When a purchase is attempted by the second (purchase) module, it may receive an error message which relates to information provided via the credit card module (e.g., that the card number provided via the first module is invalid) which the purchase module is not capable of handling. In this respect, in some embodiments, a module may be equipped with a capability of querying a collection of error codes to determine whether the module is capable of handling a particular error message. If a module receives an error message which it is not capable of handling, that module may pass the error message to client-side platform 214, which may then determine (e.g., by polling other modules) which module can handle the error message.

Using the example given above, if the purchase module receives the error message from the billing gateway, it may determine that it is not capable of handling the error message. For example, the purchase module may determine that the message includes an error code which it does not recognize. The purchase module may then forward the error message to client-side platform 214, which may then poll the remaining modules to determine whether any of them can handle the error message. In some embodiments, client-side platform 214 may send notification to each of the remaining modules in turn with an indication of the error code, so that each may perform a query to determine whether it can handle the error message. If a particular module responds to client-side platform 214 that it is capable of handling the message, client-side platform 214 may stop polling other modules. For example, if the credit card module responds that it can handle the error message, client-side platform may not need to poll other modules. In some embodiments, processing the error message may cause the credit card module to change to an expanded state on the signup facility, so as to present the error message to the user, such that the use may make any changes to information previously provided to the module.

If no module indicates to client-side platform 214 a capability of handling the error message, client-side platform 214 may cause the signup facility to display an error message to the user.

The above is merely an example of error handling capabilities which may be provided by embodiments of the invention, as numerous other options are possible. In addition, error handling functionality need not be implemented in the manner described above. For example, client-side platform 214 need not poll modules, as there may be other ways to determine which module may handle a particular error message. For example, client-side platform may maintain information indicating which module(s) may handle particular error messages. The invention is not limited to any particular implementation.

Returning to FIG. 2, client-side platform 214 may employ session data 218 in executing module(s) 216. In some embodiments, session data 218 provides information which is shared by a plurality of modules 216. In this manner, modules may be decoupled in the sense that no module need be concerned about or aware of the actions performed by other modules, but user actions taken with respect to one module which are inconsistent with user actions taken with respect to another module may be managed by client-side platform 214. In some embodiments, session data 218 comprises a data structure storing name/value pairs. Modules may “subscribe” to values stored within session data 218, such that if a value to which a module subscribes changes (e.g., as a result of a user action with respect to another module), that module may be notified by client-side platform 214 so that appropriate processing may occur. Of course, session data 218 need not be implemented as a series of name/value pairs, as any of numerous other implementation techniques are possible.

Again employing as an illustrative example the signup facility described with reference to FIGS. 1A-1C, session data 218 may ensure that the domain name and account specified via modules 110 and 120, respectively, are consistent. In this example, assume that when the user specifies a domain name via module 110, session data 218 stores the domain name as a value, and that module 120 subscribes to that value. In some embodiments, if a user specifies a domain name via module 110 and an account via module 120, then returns to module 110 and changes the domain name, client-side platform 214 informs module 120 that the domain name has been changed so that it may perform appropriate processing, such as by attempting to validate (e.g., via a network call) that the account name corresponding to the new domain name is available. If not, module 120 may, for example, register an error with client-side platform 214, which may cause client-side platform 214 to give module 120 the focus (e.g., move it to an expanded state) and present an error message to the user.

In some embodiments, session data 218 may also store data collected by a module temporarily, until the signup process is finished. For example, data may be stored by a module with instructions for client-side platform 214 to provide it back to the module once the user has completed the signup process. For example, module 110 may store the domain name provided by the user in session data 218, with instructions for client-side platform 214 to provide the domain name back to module 110 when the user completes the signup process. This feature may be useful, for example, if a module collects information that need not be stored (e.g., so as to not unnecessarily occupy storage resources) unless the signup process is completed. For example, module 110 may not attempt to store the domain name immediately after receiving it from the user. Instead, module 110 may attempt to verify that the domain name is available for registration, but not attempt to store it on the server until after the user completes the signup process.

In some embodiments, server-side platform 242 also employs session data (i.e. session data 250, FIG. 2) in coordinating the execution of components on client 210. For example, in some embodiments session data 250 is employed to ensure that web services are not abused by malicious users. In this respect, web services which support AJAX applications typically must be publicly accessible, such that any user may access them. To prevent abuse of these web services, in some embodiments, session data 250 is employed to identify malicious users. Session data 250 may be used to identify users which employ a web service without proceeding through the order of modules which is defined on a signup facility. In addition, once users are identified that employ a web service without proceeding through the defined order of modules, session data 250 may be employed in any suitable way.

Using the example once again of the signup facility depicted by FIGS. 1A-1C, if module 110 (FIG. 1A) makes a call to a web service to check if the domain name specified by a user is available for registration, in some embodiments, session data 150 is updated to reflect that the domain name web service has been called. When the user then proceeds to module 120 and specifies an account name, such that module 120 makes a call to a web service to determine whether the account already exists, in some embodiments session data 150 is checked to determine whether the domain name web service has been called. As such, session data 150, as implemented by server-side platform 242, may prevent a user from calling a web service outside the order specified on a signup facility. Thus, if a malicious or unauthorized user simply called the web service to create an account without first calling the domain name service, the request may be denied.

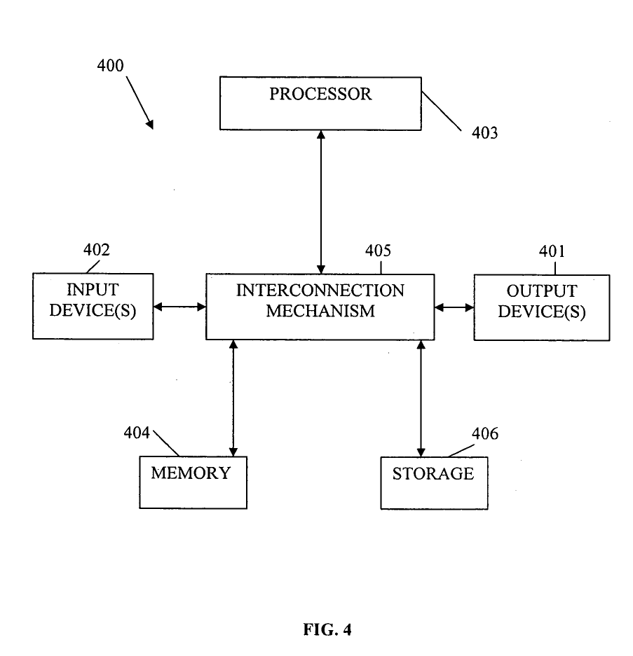

Various aspects of the systems and methods for practicing features of the invention may be implemented on one or more computer systems, such as the exemplary computer system 400 shown in FIG. 4. Computer system 400 includes input devices 402, output devices 401, processor 403, memory system 404 and storage 406, all of which are coupled, directly or indirectly, via interconnection mechanism 405, which may comprise one or more buses, switches, networks and/or any other suitable interconnection. The input devices 402 receive input from a user or machine (e.g., a human operator, or telephone receiver), and the output devices 401 display or transmit information to a user or machine (e.g., a liquid crystal display). The processor 403 typically executes a computer program called an operating system (e.g., a Microsoft Windows (R)-family operating system or other suitable operating system) which controls the execution of other computer programs, and provides scheduling, input/output and other device control, accounting, compilation, storage assignment, data management, memory management, communication and data flow control. Collectively, the processor and operating system define the computer platform for which application programs in other computer programming languages are written.

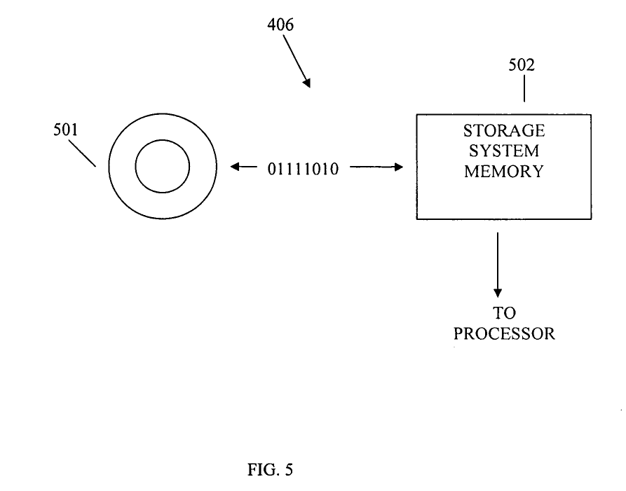

The processor 403 may also execute one or more computer programs to implement various functions. These computer programs may be written in any type of computer programming language, including a procedural programming language, object-oriented programming language, macro language, or combination thereof. These computer programs may be stored in storage system 406. Storage system 406 may hold information on a volatile or nonvolatile medium, and may be fixed or removable. Storage system 406 is shown in greater detail in FIG. 5.

Storage system 406 typically includes a computer-readable and writeable nonvolatile recording medium 501, on which signals are stored that define a computer program or information to be used by the program. The medium may, for example, be a disk or flash memory. Typically, in operation, the processor 403 causes data to be read from the nonvolatile recording medium 501 into a volatile memory 502 (e.g., a random access memory, or RAM) that allows for faster access to the information by the processor 403 than does the medium 501. This memory 502 may be located in storage system 406, as shown in FIG. 5, or in memory system 404, as shown in FIG. 4. The processor 403 generally manipulates the data within the integrated circuit memory 404, 502 and then copies the data to the medium 501 after processing is completed. A variety of mechanisms are known for managing data movement between the medium 501 and the integrated circuit memory element 404, 502, and the invention is not limited thereto. The invention is also not limited to a particular memory system 404 or storage system 406.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface including keyboards, and pointing devices, such as mice, touch pads, and digitizing tables. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. In a system comprising a client computer, a server computer and at least one communication medium coupling the client computer to the server computer, the client computer executing a browser program operable to display to a user at least one web page provided by the server computer to the client computer, a method of providing a signup facility which the user employs to provide signup information, the method comprising an act of:
(A) causing the signup facility to be displayed to the user via a single web page, the signup facility including a plurality of modules, at least one of the plurality of modules being capable of assuming a plurality of states on the web page, the plurality of states comprising a first state in which one or more input mechanisms are presented to the user for providing signup information and a second state wherein the module occupies less viewable area than in the first state.

2. The method of claim 1, wherein the plurality of modules are arranged vertically on the web page.

3. The method of claim 1, wherein the plurality of modules are visible to the user in a single viewable area.

4. The method of claim 1, wherein the plurality of states further comprises a third state in which a portion of signup information provided by the user is displayed.

5. The method of claim 1, wherein the act (A) is performed by the client computer.

6. The method of claim 1, wherein the act (A) is performed by the server computer.

7. The method of claim 1, wherein each of the plurality of modules receives signup information which comprises a set of logically related items.

8. A server computer for use in a system comprising the server computer, a client computer and at least one communication medium coupling the client computer to the server computer, the client computer executing a browser program operable to display to a user a web page provided by the server computer to the client computer, the server computer comprising:
a server-side platform component operable to receive a request from the client computer and, in response to receiving the request, provide a set of programmed instructions which, when executed on the client computer, causes a signup facility to be displayed to the user on a single web page, the signup facility including a plurality of modules, at least one of the plurality of modules being capable of assuming a plurality of states on the web page, the plurality of states comprising a first state in which one or more input mechanisms are presented to the user for providing signup information and a second state wherein the module occupies less viewable area than in the first state.

9. The server computer of claim 8, further comprising:
an experience manager component, in communication with the server-side platform component, operable to, upon the request being received from the client computer, determine an experience to be presented to the user via execution of the set of programmed instructions on the client computer, the experience defining the display of the plurality of modules on the web page; and
wherein the set of programmed instructions, when executed on the client computer, causes a signup facility to be displayed in accordance with the experience.

10. The server computer of claim 9, wherein the experience manager component is further operable to maintain a plurality of experiences and select one of the plurality of experiences upon the request being received from the client computer, and wherein the set of programmed instructions, when executed on the client computer, causes a signup facility to be displayed in accordance with the selected experience.

11. The server computer of claim 8, wherein the set of programmed instructions comprises a first group of programmed instructions which, when executed on the client computer, defines a client-side platform component operable to instruct each of the plurality of modules to assume one of the plurality of states.

12. The server computer of claim 8, wherein the set of programmed instructions comprises at least one set of instructions provided in asynchronous Javascript and XML (AJAX) form.

13. The server computer of claim 8, wherein the set of programmed instructions, when executed on the client computer, initiate communication with the server computer without the browser program requesting a web page.

14. At least one computer-readable medium having instructions encoded thereon which, when executed by a client computer in a system comprising the client computer, a server computer and at least one communication medium coupling the client computer to the server computer, the client computer executing a browser program operable to display to a user a web page provided by the server computer via the network to the client computer, perform a method comprising an act of:
(A) display a signup facility to the user on a single web page, the signup facility including a plurality of modules, at least one of the plurality of modules being capable of assuming a plurality of states on the web page, the plurality of states comprising a first state in which one or more input mechanisms are presented to the user for providing signup information and a second state wherein the module occupies less viewable area than in the first state.

15. The at least one computer-readable medium of claim 14, wherein the plurality of modules are arranged vertically on the web page.

16. The at least one computer-readable medium of claim 14, wherein the plurality of modules are visible to the user in a single viewable area.

17. The at least one computer-readable medium of claim 14, wherein the plurality of states further comprises a third state in which a portion of signup information provided by the user is displayed.

18. The at least one computer-readable medium of claim 17, wherein the plurality of modules comprises a first module and a second module, and wherein:
at a first time when the user indicates a willingness to provide signup information to the first module, the first module assumes the first state; and
at a second time when the user indicates a willingness to stop providing signup information to the first module and to proceed with providing input to the second module, the first module assumes the second state and the second module assumes the first state.

19. The at least one computer-readable medium of claim 18, wherein at a third time, subsequent to the second time, when the user indicates a willingness to stop providing input to the second module and to return to providing input to the first module, the second module assumes the third state and the first module assumes the first state.

20. The at least one computer-readable medium of claim 14, wherein each of the plurality of modules receives signup information which comprises a set of logically related items.
